(19) United States
(12) Patent Application Publication
(10) Pub. No.: US 2018/0082357 A1
(43) Pub. Date: Mar. 22, 2018

(54) METHOD FOR DISPLAYING SEARCH RESULTS FOR ITEMS WITH ENVIRONMENTAL ATTRIBUTES

(71) Applicant: Evan John Kaye, New York, NY (US)

(72) Inventor: Evan John Kaye, New York, NY (US)

(21) Appl. No.: 15/709,867

(22) Filed: Sep. 20, 2017

Related U.S. Application Data
(60) Provisional application No. 62/397,200, filed on Sep. 20, 2016.

(51) Int. Cl. G06Q 30/06; G06F 17/30

(52) U.S. Cl. CPC G06Q 30/0639; G06F 17/30864; G06Q 30/0627; G06Q 30/0643

(57) ABSTRACT

A method is provided comprising steps (a) displaying a symbol that is proportional in size to a number of search results in a aggregated georeferenced search result set, the symbol superimposed on a map in a position that geographically corresponds to a position attribute of the aggregated georeferenced search result set, the symbol comprising at least two areas that are essentially proportional in size to the number of results that have a price attribute value within price ranges that correspond to said at least two areas; (b) enabling a user to dynamically modify parameters that define the limits of the price ranges through a price range modification mechanism; (c) updating the at least two areas as the user manipulates said price range modification mechanism; (d) enabling the user to dynamically modify environmental parameters comprising a temperature modification mechanism and a solar modification mechanism; and (e) updating the number of search results as the user manipulates the environmental parameters.

### CROSS-REFERENCE TO RELATED APPLICATIONS

The present application claims priority to U.S. Provisional Patent Application Ser. No. 62/397,200, filed on Sep. 20, 2016 entitled “Method for Displaying Search Results for Items with Environmental Attributes”, the disclosure of which is hereby incorporated in its entirety at least by reference.

### BACKGROUND OF THE INVENTION

### 1. Field of the Invention

The present invention relates to a method for displaying search results for items with environmental attributes.

### 2. Description of Related Art

Purchasing tickets for a live outdoor event with reserved seats has become a common transaction on the internet. Events may be a sporting event, a music concert, outdoor theater, or anything else. The user typically uses an internet browser to interact with a website for this purpose, or uses a mobile application specifically designed for this purpose. In many cases, the user is able to select the section, row or even specific seats for the event. However, it is unknown what the environmental attributes corresponding to the selected seats will be. Consequently, there is a need for a method for displaying search results for items with environmental attributes, such as environmental conditions a selected seat is subject to.

### BRIEF SUMMARY OF THE INVENTION

In one embodiment of the present invention a method for displaying search results for items with environmental attributes.

### BRIEF DESCRIPTION OF THE SEVERAL VIEWS OF THE DRAWINGS

It is to be understood that the drawings are to be used for the purposes of exemplary illustration only and not as a definition of the limits of the invention. Throughout the disclosure, the word “exemplary” is used exclusively to mean “serving as an example, instance, or illustration.” Any embodiment described as “exemplary” is not necessarily to be construed as preferred or advantageous over other embodiments. Referring to the drawings in which like reference character(s) present corresponding part(s) throughout:

FIG. 1 illustrates an exemplary network arrangement of hardware and software for implementing a method according to an embodiment of the present invention.

FIG. 2 shows an exemplary search form for searching for desired event tickets according to an embodiment of the present invention.

FIG. 3 shows an exemplary selection form for searching for selecting desired events according to an embodiment of the present invention.

FIG. 4 shows an exemplary selection with scheduling conflict alerts for searching for selecting desired events according to an embodiment of the present invention.

FIG. 5 is an exemplary architectural diagram of an Internet computer network system according to an embodiment of the present invention.

FIGS. 6A-D show exemplary graphically interactive selection forms for selecting desired ticket offers according to an embodiment of the present invention.

FIG. 7 shows an exemplary selection form for reviewing and selecting tickets among a group of user defined favorites according to an embodiment of the present invention.

FIG. 8 shows an exemplary email for sending selections or user defined favorites to another user via electronic mail according to an embodiment of the present invention.

FIGS. 9A-B are flowcharts illustrating a process a user searches for and selects tickets for events according to an embodiment of the present invention.

### DETAILED DESCRIPTION OF THE PREFERRED EMBODIMENT

The following description is provided to enable any person skilled in the art to make and use the invention and sets forth the best modes contemplated by the inventor of carrying out their invention. Various modifications, however, will remain readily apparent to those skilled in the art, since the general principles of the present invention have been defined herein to specifically provide a method for displaying search results for items with environmental attributes.

Purchasing tickets for a live outdoor event with reserved seats has become a common transaction on the internet. Events may be a sporting event, a music concert, outdoor theater, or anything else. The user typically uses an internet browser to interact with a website for this purpose, or uses a mobile application specifically designed for this purpose. In many cases, the user is able to select the section, row or even specific seats for the event. In a previous invention, application Ser. No. 11/847,827, filed Aug. 30, 2007, titled “Method for Displaying Search Results for Items with Geographic Attributes”, herein incorporated by reference. I disclosed a means to filter available seats by a variety of factors, such as price and number of contiguous seats available. The matching results after filtering being displayed in an aggregated manner on a seat map.

The present invention pertains to the utilization of solar and weather information to help the user make a more informed decision when selecting seats for a live event. The invention assumes that the solar data are available for the venue. The solar data is specific to a specific venue which is at a specific geographic location. It is also specific to a time of year as the sun will track differently depending on the time of year. In one embodiment, it may be specific to a specific date on the Gregorian calendar, which being a solar calendar defines a specific sun path, and sun phase for a specific date which is substantially the same path and phase as that date in all other years aside from minor leap year adjustments. Since live sports events and concerts generally have a duration of several hours, the data may be limited to only the time of the event. In one embodiment, the data may also be of varying temporal resolution. For instance it may describe the state (whether in the sun or shade) of a given region of the stadium at a particular point in time, and then an hour later, and an hour after that (a one-hour temporal resolution), or it may be more granular and describe the state of a region every half hour, or even every minute. In one embodiment, the data may also vary with regards to the spatial resolution. In another embodiment, it may describe the predominant state of a section in the stadium at a particular point in time, or the predominant state of a specific row in a section. In one embodiment, it may be so granular as to describe the state of a particular seat in a row of a section of the stadium at a particular point in time. It should be understood that the data may be gathered in a number of different ways that does not depart from the spirt and scope of this invention.

What is needed in the art and has heretofore not been described is a means to appreciate whether a seat or group of seats, at an outdoor venue will be entirely in the shade, sunlight, or a combination thereof during a live event. On a cold day the user's preference may be for sunlight, whereas on a hot day the user's preference may be for shade. One aspect of this invention pertains to a means to represent in a symbolic way which sections, rows, or even seat positions will be in one of the above statuses (shade, sun, or combination), and also the amount of time it will be in each state.

The forecasted weather, both the ambient temperature, and the degree of cloud cover are important considerations as to the utility and interpretation of the data. For instance, on a cool day with significant cloud cover there will not be a large difference in the experience of sitting in the sun compared to the shade. But on a cool day where there are no clouds there's a significant difference between a seat in the shade compared to a seat in the sun.

Each row in every section has 24 digits each responding to whether it is in the sun (1) or shade (0) at the beginning of that hour of the day . . . .

```
  ″}, {″date″: ″2016-4-
  1″, ″sun″: ″000000001111111110000000″}, {″date″: ″2016-4-
  2″, ″sun″: ″000000001111111110000000″}, {″date″: ″2016-4-
  3″, ″sun″: ″000000001111111100000000″}, {″date″: ″2016-4-
  4″, ″sun″: ″000000001111111110000000″}, {″date″: ″2016-4-
  5″, ″sun″: ″000000001111111110000000″}, {″date″: ″2016-4-
  6″, ″sun″: ″000000001111111110000000″}, {″date″: ″2016-4-
  7″, ″sun″: ″000000001111111110000000″}, {″date″: ″2016-4-
  8″, ″sun″: ″000000001111111110000000″}, {″date″: ″2016-4-
  9″, ″sun″: ″000000001111111100000000″}, {″date″: ″2016-4-
10″, ″sun″: ″000000001111111100000000″}, {″date″: ″2016-4-
11″, ″sun″: ″000000001111111100000000″}, {″date″: ″2016-4-
```

By way of overview and introduction, a method in accordance with a preferred embodiment of the invention provides a multi-step process for a user to search and select desired event tickets at a venue, ultimately leading to the purchase of those tickets. First, the user is presented with a web page form comprising an input field and a search button. The user enters a search phrase/keyword and begins a search upon submitting the form. Users may also initiate a search by clicking on one of the link options displayed above the form. Second, the matching results are retrieved from the ticket search website database and displayed alphabetically according to venue in tabular form. The user may then select one or more events at a venue and the number of tickets desired. Third, the user is presented with a new page displaying the venue map and seat information. The user may find tickets by adjusting a price range, by clicking on the venue map, and utilizing solar and weather information. When the user is satisfied, the user may then click the Buy Now button to be transferred to a ticket seller's site.

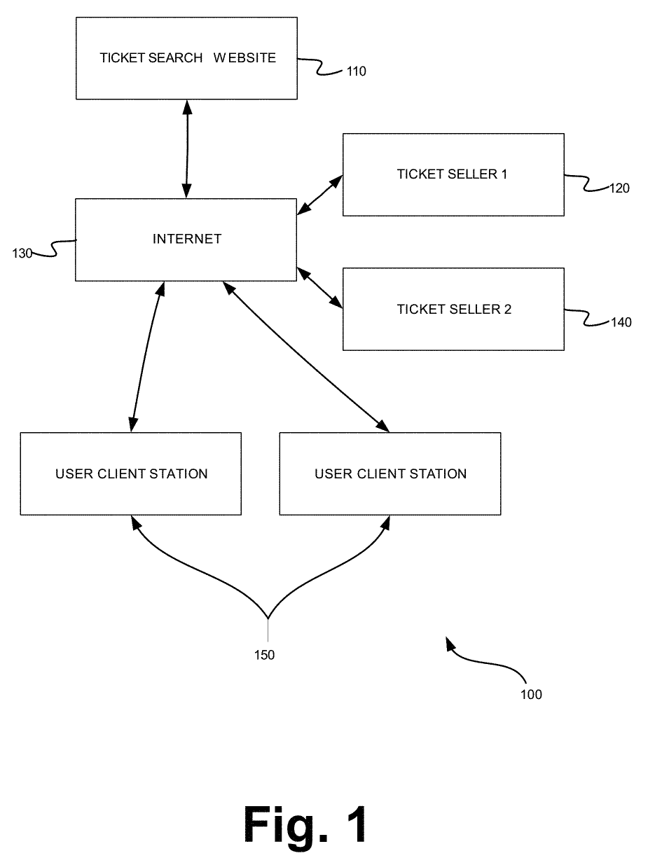

With reference now to FIG. 1, a network arrangement of hardware components 100 for implementing a method in accordance with the present invention is described. The network 100 includes a Ticket Search Site 110 which provides content over the Internet 130 to a plurality of distributed users that access the ticket search site through user client stations 150. The content provided by the ticket search site can be viewed by users through a World Wide Web browser or other functionally equivalent software running at their respective user client stations 150. The user client stations can assume a variety of forms, including but not limited to a home computer, a cellular phone, a PDA, an Internet compliant telephone, or other Internet compliant communications device.

In one embodiment, the ticket search site communicates with a plurality of ticket sellers, represented here by Ticket Seller 1 120 and Ticket Seller 2 140, to retrieve and synthesize ticket availability data. Ticket Seller 1 120 and Ticket Seller 2 140 make their lists of purchasable tickets available to Ticket Search Site 110 via the Internet 130 through public websites that Ticket Search Site 110 can crawl the way search engines typically operate, through web services, through syndication (e.g. RSS), or through other electronic means as known by those of skill in the art. Through the use of the Ticket Search Site users can access and search through ticket offerings aggregated from a variety of sources.

In one embodiment, the Ticket Search Site, Ticket Seller 1 and Ticket Seller 2, and user client stations are configured to communicate with one another in a conventional manner over communication link through the Internet. In lieu of the Internet, communications can be through an intranet or Extranet, as understood by those of skill in the art.

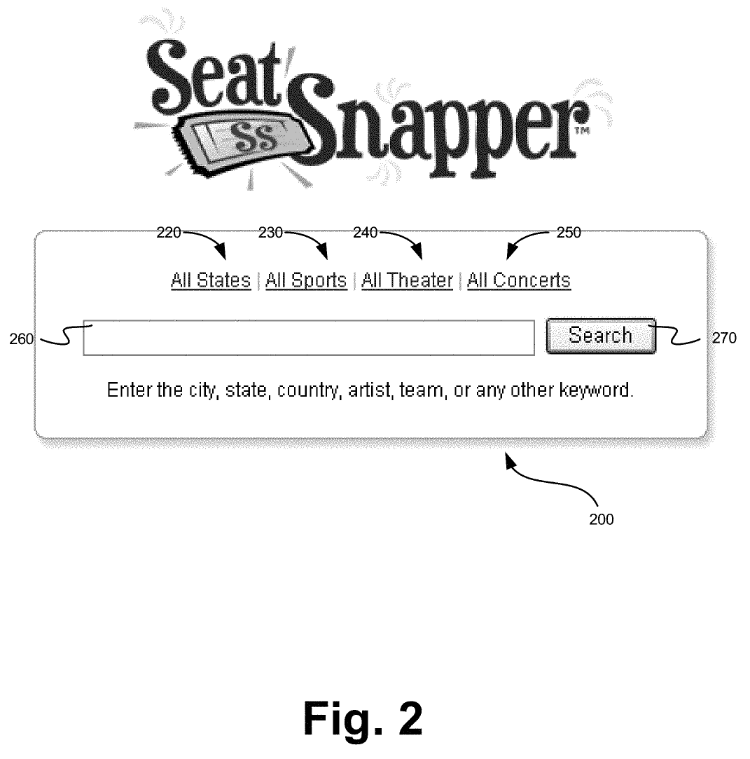

FIG. 2 shows an exemplary search form 200 used to search for desired event tickets in accordance with the preferred embodiment of the invention. The search form is generated on the Ticket Search Site and can be implemented as an HTML file having form tags, or as an ActiveX, JavaScript, DHTML, Flash or other component that executes on the client station, as understood by those of skill in the art.

The search form 200 comprises an input field 260, a search button 270, and a plurality of quick search link options allowing the user to view all events belonging to a particular category or type. The plurality of quick search link options are made available as website links, being All States 220, All Sports 230, All Theater 240, and All Concerts 250 links respectively. The user selects the search button to submit the form to the Ticket Search Site 110 in FIG. 1.

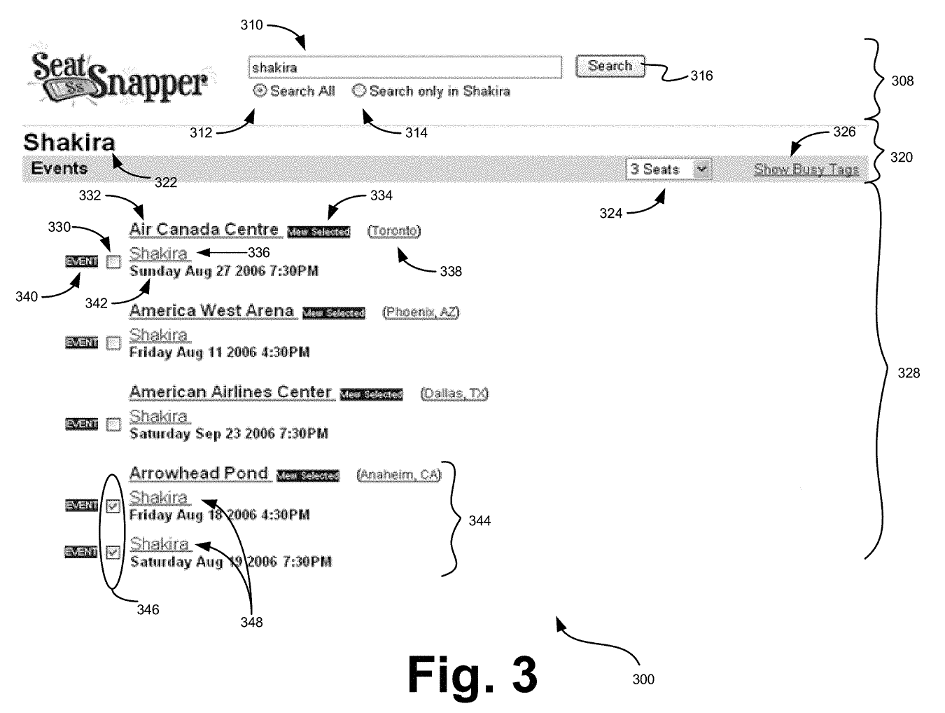

FIG. 3 shows an exemplary selection form 300 for selecting desired events in accordance with the preferred embodiment of the invention. The selection form is a response from the server when the user submits form 200 (FIG. 2), and is divided into three regions: a header region 308, a modification panel 320, and a selection region 328. The header region includes a search form comprising an input field 310 and two radio buttons which allow the user to search the entire ticket network site, by selecting the Search All radio button 312 or to search within the search results of the previous search term, by selecting the Search Only In 314 radio-button before clicking a search button 316.

In one embodiment, below the header region is the modification panel. The modification panel comprises a Title 322 and tools for manipulating the search results. These tools include a drop-down menu box 324 which enables the user to select the desired quantity of seats and a Show Busy Tags link 326 which allows the user to interface with client-based or remotely stored calendar information (for example, Google Calendar) to determine which events conflict with appointments conflict with events displayed in the search results.

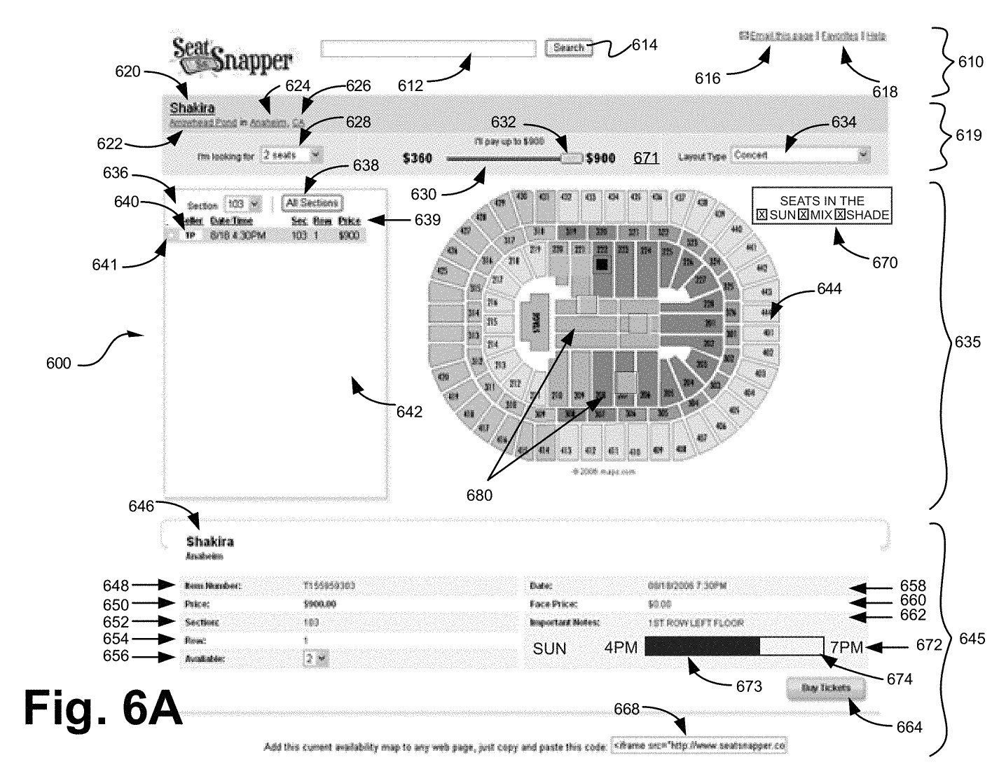

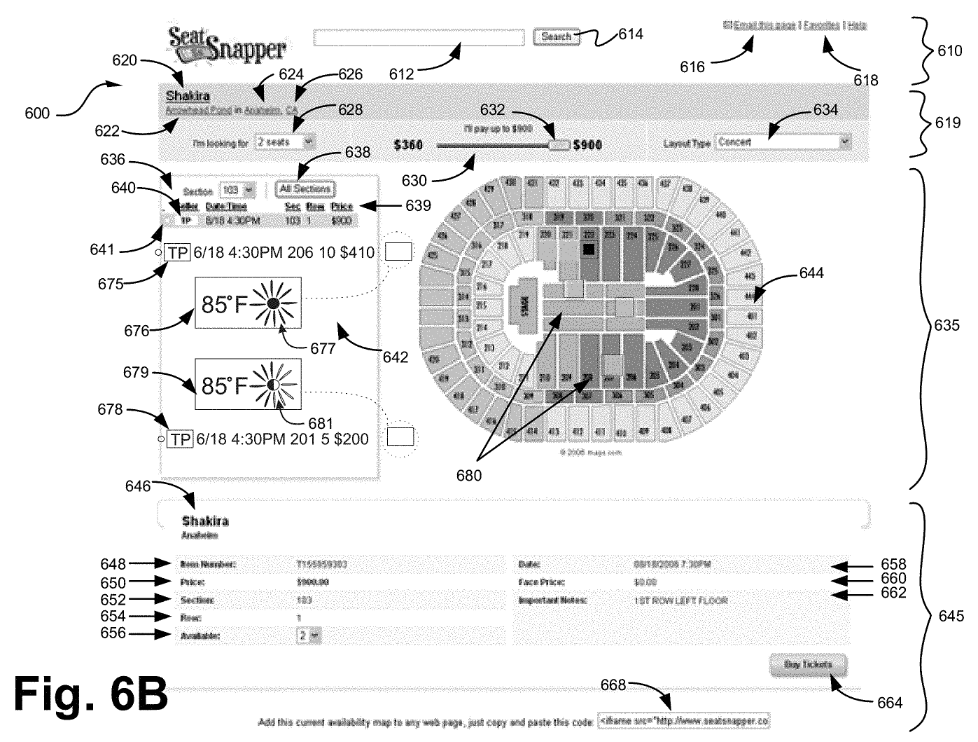

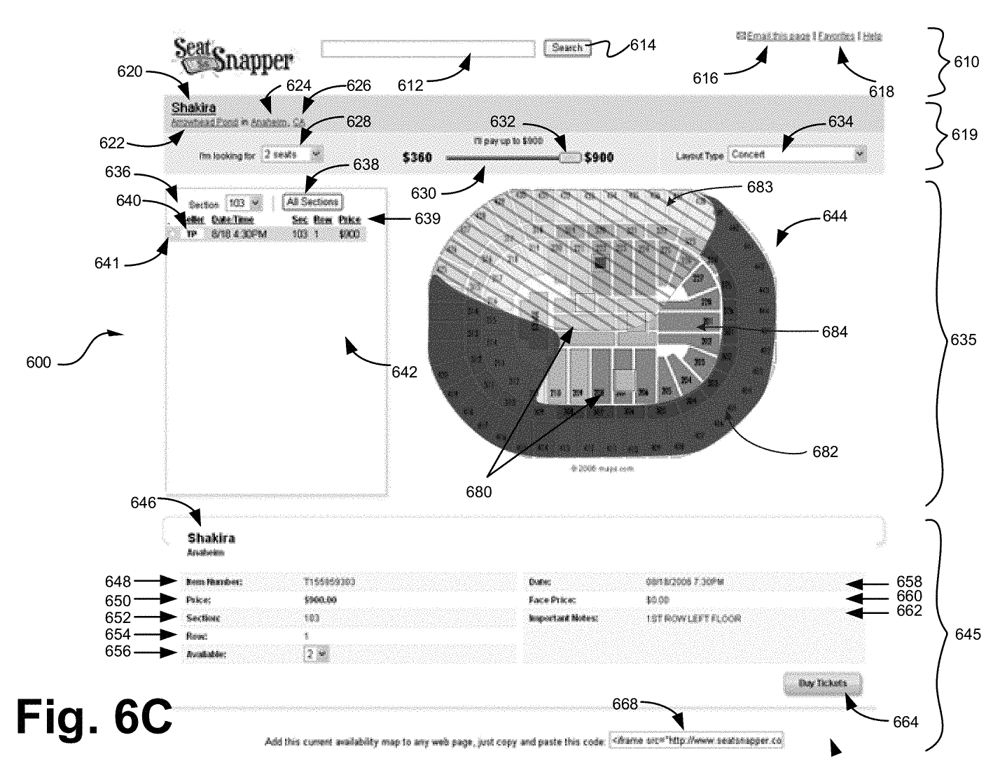

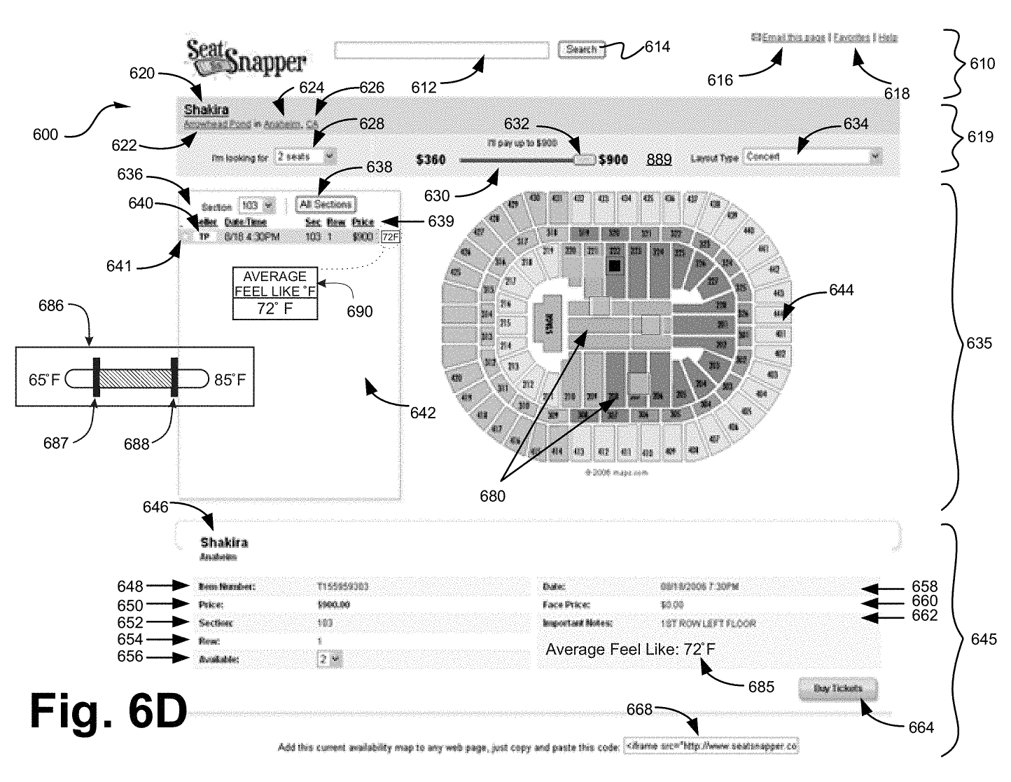

In one embodiment, the selection region is below the modification panel and displays those venues which contain matching events. Matching events are designated by an Event Tag 340 and are displayed under their respective venues in a set format which contains a Venue Name 332, a Venue City 338, an Event Name 336, and an Event Date/Time 342. The user may select an event by placing a check in a check-box 330 adjacent to the Event Name and by then clicking on a View Selected button 334, or alternatively by just clicking the Event Name. The method of checking the check-box is especially useful when multiple events need to be selected by the use. To illustrate this, a venue with multiple events 344 is shown. When a user checks off check-boxes 346 corresponding to both Event Names 348 respectively, then ticket listings from both events will be shown, in aggregate, on the interactive venue map of FIG. 6, which the user is able to navigate to by clicking the View Selected link. As only one interactive venue map of FIG. 6 can be displayed at a time, checkboxes 346 adjacent to the multiple events that are selected, would automatically be cleared should a user select a checkbox that does not correspond to the same venue (for example, checkbox 330 adjacent to event 336, which corresponds to an event at Air Canada Centre). The user may also click on the Venue Name to select every check-box 330 next to each of the Venue Name's Event Names. There is also a Venue City link 338 that indicates to the user where the respective venue is located, and the user can click it to link to a page that displays all events in that city.

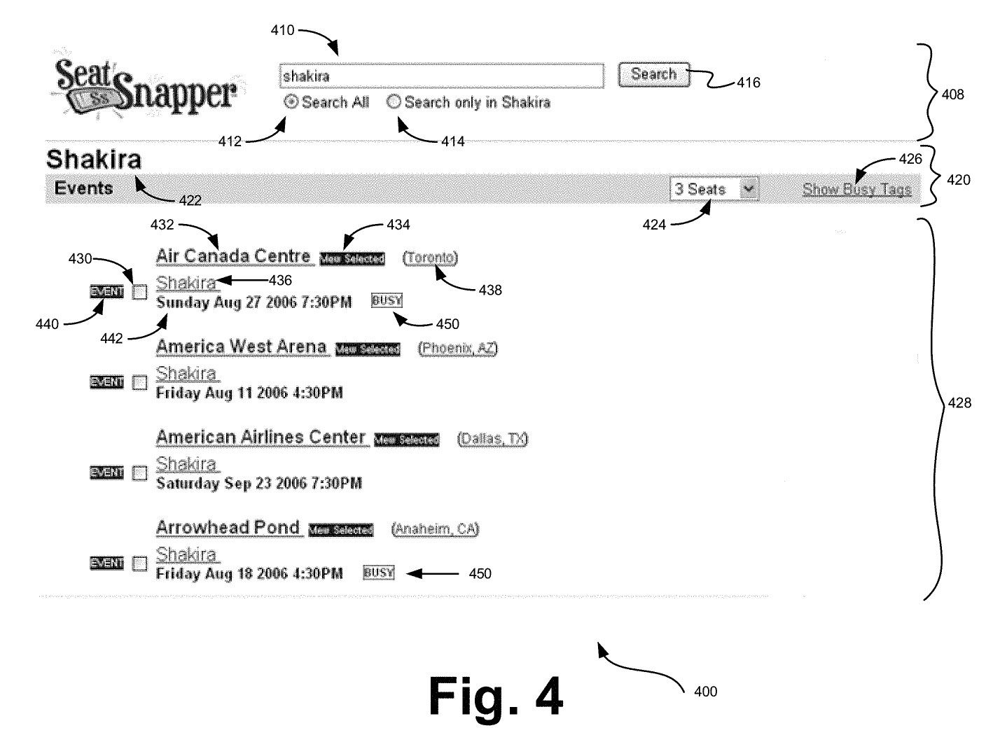

FIG. 4 shows an exemplary selection form 400 for selecting desired venue events in accordance with the preferred embodiment of the invention, and is essentially the same as form 300 of FIG. 3, but differs in that it contains Busy Tags 450 indicating to the user which events in the search results conflict with existing appointments on their calendar. In one embodiment, the selection form is divided into three region types: a header region 408, a modification panel 420, and a selection region 428. The header region includes a search form comprising an input field 410 and two radio buttons which allow the user to search the entire ticket network site, by selecting the Search All radio button 412 or to search within the search results of the previous search term, by selecting the Search Only. In 414 radio-button before clicking a search button 416. Below the header region, the modification panel comprises a Title 422 and tools for manipulating the search results. These tools include a drop-down menu box 424 which enables the user to select the desired quantity of seats and a Show Busy Tags link 426 which allows the user to interface with client-based or remotely stored calendar information (for example, Google Calendar) to determine which events conflict with appointments conflict with events displayed in the search results. The selection region is below the modification panel and displays those venues which contain matching events. Matching events are designated by an Event Tag 440 and are displayed within their respective venues in a set format which contains a Venue Name 432, a Venue City 438, an Event Name 436, and an Event Date/Time 442. The user may select an event by clicking check-box 430 adjacent to Event Name 436 and by then clicking on a View Selected button 434. The user may also click on Venue Name 432 to select every check-box 430 next to each of the Venue Name's Event Names 436. There is also a Venue City link 438 that indicates to the user where the respective venue is located, and the user can click it to search for all events in that city. The selection form contains Busy Tags 450, which are displayed adjacent to Events that conflict with the user's schedule according to calendar information retrieved from an electronic calendar. The Busy Tags are for informational purposes only to the user, and do not hinder the user from selecting any desired option. If a user holds their mouse over one of the Busy Tags, then details of the appointment on their calendar appear as a tooltip.

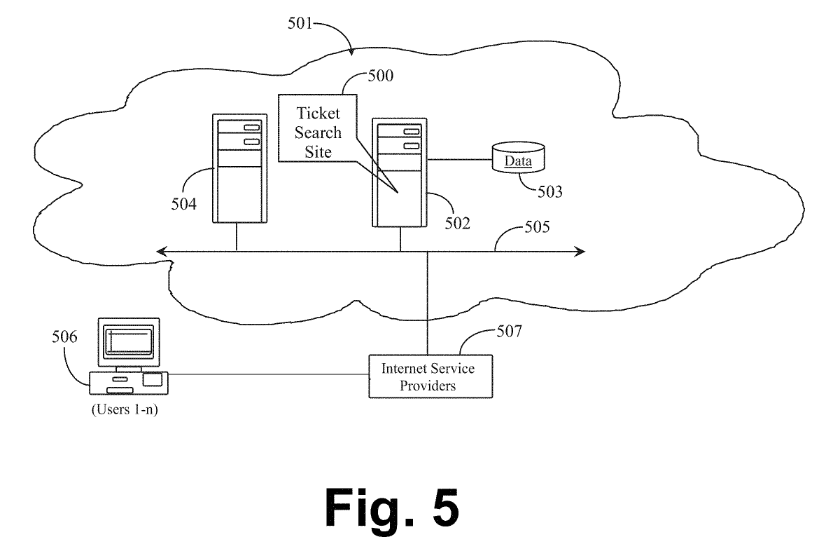

FIG. 5 is an exemplary architectural diagram of an Internet 501 computer network system according to an embodiment of the present invention. The Internet-connected system comprises one or more Internet-connected servers 502 executing Ticket Search Site 100 software from non-transitory media. Server 502 is connected to a data repository 503, which may be any sort of data storage known in the art. The system further comprises a third party Internet-connected server 504 connected to Internet backbone 505. Although one third party Internet-connected server 504 is shown, it is understood that potentially millions of other similar servers are connected to the Internet via Internet backbone 505. A number of users (1-n) 506 are connected to the Internet-connected server via an Internet service provider (ISP) 507, allowing users 506 to access the Ticket Search Site.

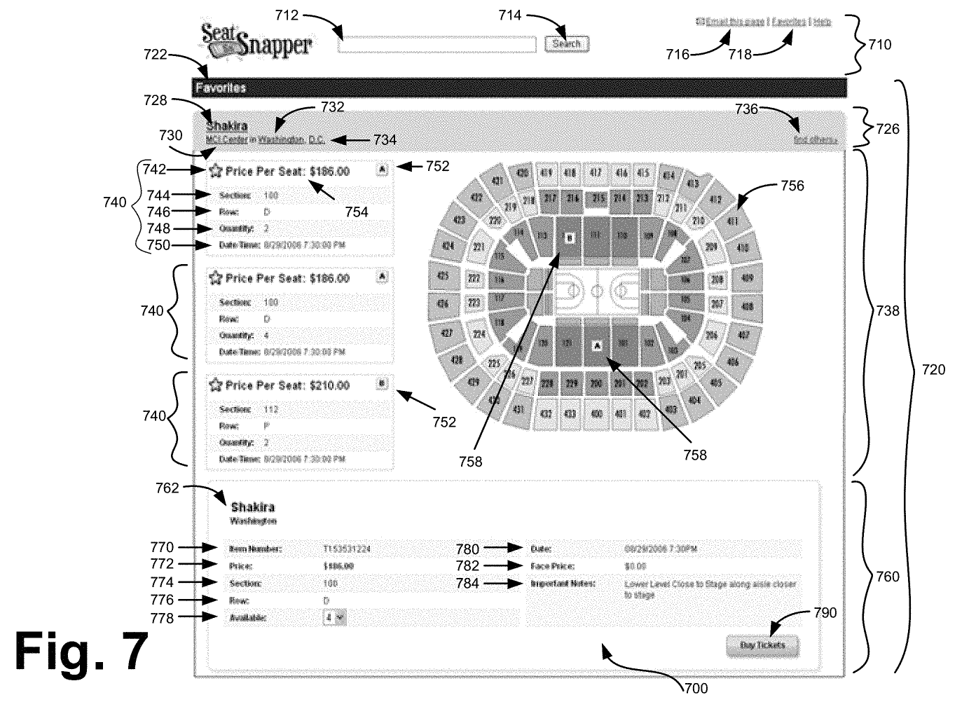

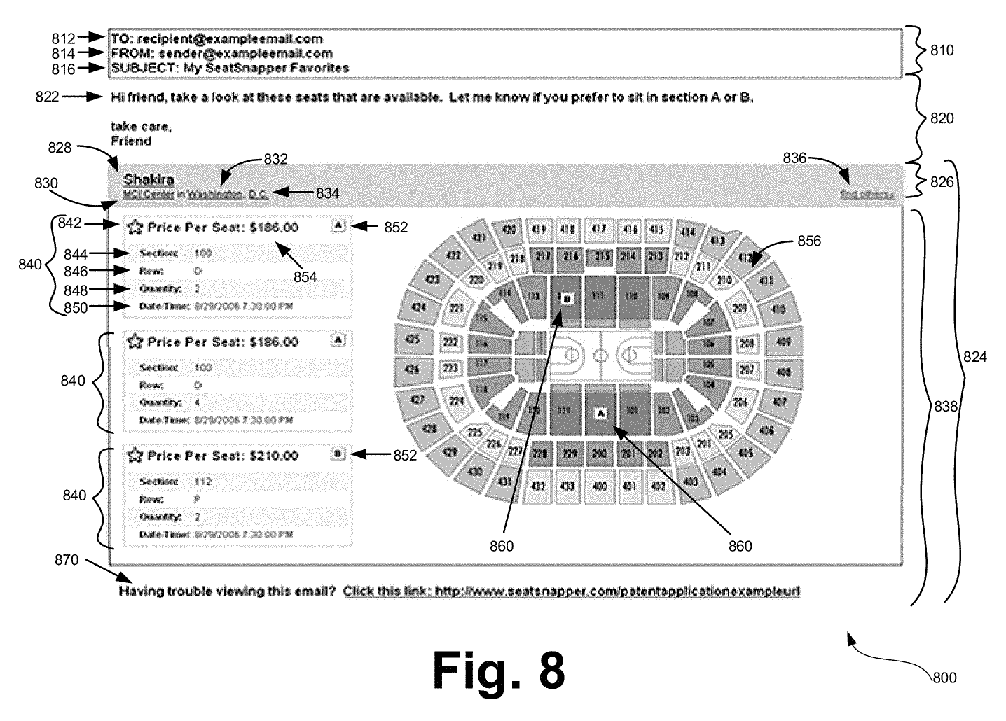

FIGS. 6A-D show exemplary graphically interactive selection forms for selecting desired ticket offers according to an embodiment of the present invention. Referring now to FIG. 6A-D, an exemplary graphically interactive selection form 600 for selecting desired ticket groups is shown. The selection form is divided primarily into four regions: a header region 610, a modification panel 619, a selection region 635, and an information panel 645. The header region includes a search form comprising an input field 612 and a search button 614. This enables the user to search the entire site upon entering a keyword or search phrase. The header region also contains two links; an Email This Page link 616 enables the user to email the page to another individual and a Favorites link 618 allows the user to view items that they have selected as their ‘Favorites’ as described in more detail with respect to FIG. 7. Below the header region, the modification panel comprises a Title 620 which is the name of the Event selected on form 300 of FIG. 3, but may instead be the name of the Venue if different Event Names are represented on the page. In one embodiment, a Venue Name 622, a Venue City 624, and State Name 626 are represented under Title 620, when the Title is an Event Name. In addition, there are three tools for manipulating the tickets results displayed. The first tool is a Quantity drop-down menu box 628 which enables the user to select the desired quantity of seats. The second tool is a dynamic slider 632 that the user can drag along a price range continuum 630 by clicking and dragging their mouse to adjust their price range. The third tool is a venue layout type drop-down menu box 634 which allows the user to adjust the venue layout type (eg. Concert, Tennis, Basketball, etc.). Depending on the selected venue layout type, a graphical venue map 644 will change accordingly.

In one embodiment, the selection region resides below the modification panel and displays a tabular output of tickets 642 that meet the user-defined specifications as set in the modification panel and the Section drop-down menu box. The selection region also contains the graphical map of the venue, corresponding to the selected layout type as determined from the drop-down menu box as previously mentioned. Within the ticket display table 642, the listing of tickets 640 for a specific section can be altered via the section drop-down menu box 636. Alternatively, users may click the All Sections button 638 to view the tickets from all sections corresponding to the user-defined specifications set in the modification panel. Other options include the ability to add or remove a ticket to ‘Favorites’ by clicking on the star 641 to the left of the ticket. Users may also sort tickets according to price, row, section, and date/time as listed on row 639 of the ticket display table 642.

In one embodiment, the graphical map of the venue has symbols 680 displayed on it representing tickets that are available in the region of the venue over which the symbol is displayed. As the price range is adjusted by the dynamic slider, the symbols on a graphical map of the venue 644 change dynamically to represent the number of seats available in the user's price range in the region of the graphical map of the venue underlying the symbol. In one embodiment, a large symbol represents more seats available, and the proportion of colors in the symbol represents to the user the corresponding proportion of tickets that are available in the user's price range. By clicking on one of the symbols the user can change the selection in the drop down menu box to correspond with the section represented by said symbol. This action in turn changes the listing of tickets available on the ticket display table to those that are specific for the selected section.

It should be stated, that while the size of the symbols are determined primarily by the number of tickets they represent, an algorithm determines if any of the symbols will overlap each other given their proximity and the size they were primarily determined to be. If so, all symbols are decreased in size proportionally to minimize the overlap. There are maximum and minimum sizes for the symbols that override all aforementioned rules.

In one embodiment, below the selection region, the information panel displays detailed information about an item selected in the ticket display table, which the user selects by clicking on an individual ticket listing 640. The information provided includes the name and location of the event in header 646, an item number 648, price 650, section 652, row 654, number of tickets available 656, date and time 658, face price 660, and important notes about the ticket 662. Below this information is a Buy Ticket button 664 which directs users to a ticket seller's website to buy the selected tickets. Also within this panel is the source code necessary to display this page in a frame on another website 668, should the user want to dynamically display ticket availability information for a particular event or number of events, on their own web page.

Now referring to FIG. 6A, in one embodiment, a solar selection filter 670 is provided. In one embodiment, the solar selection filter is located in the modification panel at position 671. The solar selection filter allows the user to select a solar selection including sun, shade, and mix to filter the number of seats which is represented on the graphical map of the venue. In this instance, the graphical map of the venue will display available seats according to the solar selection. For instance, if sun is selected on the solar selection filter, only shows seats in sun. In one embodiment, based on the time of the event (rounded down), and duration of the vent and predicted end time (rounded up), a solar data display 672 is provided. The solar display shows the solar data of a selected seat, including time the seat is in the sun 673 and time the selected seat is the shade 674. In one embodiment, the solar display is represented by a rectangular horizontal bar graph comprising a first bar representing sun 673 and a second bar representing shade 674. The user can visualize the time the seat is in the sun and shade based on the event duration as previously mentioned. In this embodiment, multiple events may be listed.

Now referring to FIG. 6B, listing of tickets 675, and 678 comprise weather forecasts 676, and 679 respectively. Although not shown, the listing of ticket 640 may also include a weather forecast in this embodiment. The weather forecasts include the temperature and a sun diagram. The sun diagram visually illustrates if the corresponding seat is in the shade, sun, or mixed a combination of sun and shade. For instance, sun diagram 677 has all the sun rays filled in black implying the corresponding seat is completely in the shade for the duration of the event. Likewise, sun diagram 681 has half the sun rays filled in black and the other half yellow or lack of color fill implying the corresponding seat is partially in the sun and partially in the shade, in the case an equal amount of time for the duration of the event. Depending on the amount of sun rays filled in black or yellow, a user can determine how much of the event the corresponding seat is in the sun and shade. In this embodiment, multiple events may be listed.

Now referring to FIG. 6C, in one embodiment, the graphical map of the venue 644 includes transparent solar conditions projected directly on the graphical map. For instance, area colored black 682 represents seats in the shade for the duration of the event. Area colored black and yellow 683 represents seats partially in the sun and shade for the duration of the event. Likewise, area colored yellow 684 represents seats in the sun for the duration of the event.

Now referring to FIG. 6D, in one embodiment, a temperature filter element 686 is provided at location 889 in the modification panel. The temperature filter element allows a user to filter the average temperature, or the average “feels like” temperature forecasted. The temperature filter element comprises two sliders 687 and 688 to control the range of temperatures filtered. In one embodiment, the range of temperatures is displayed on either end of the sliders to visually show the user what the current filtered range of temperature is selected. For instance, if the temperature filter element is positioned from 65 degrees to 85 degrees, only seats with forecasted temperatures in this range will populate. In one embodiment, the listing of ticket displays the average “feels like” temperature 690 of the corresponding seat. Similarly, the average “feels like” temperature 685 is also displayed in the information panel. The average “feels like” temperature factors in sun, and wind speed and is averaged over the duration of the event, it is not the ambient temperature. The average “feels like” temperature can be referred to as the apparent temperature or the relative outdoor temperature.

For a given venue, and a given point in time (e.g. 2:00 PM local time), the seats that are in the shade may be regarded as all experiencing the same apparent ambient temperature, informed by dry bulb temperature, water vapour pressure, and wind chill index; and the seats in the sun can be regarded as the baseline apparent ambient temperature plus some additional heat factor. This additional heat factor is the solar irradiance factor, and is a function of many variables including the position of the sun in the sky, and the degree of cloud cover. The solar irradiance factor is a critical value for solar panels, so the tools to calculate this factor are well described. For instance, the National Renewable Energy Laboratory's Measurement and instrumentation Data Center's tool can be used to estimate intensity of the sunlight without cloud cover, and then a cloud cover algorithm:

R=R₀(1−0.75 n^{3.4})
where
   R=solar radiation
   n=cloud cover (0.0-1.0)
and
R₀=990 sin(SEA)−30
where
   SEA=solar elevation angle

The cloud cover algorithm can be applied to the intensity estimate to decrease solar irradiance factor if necessary. While the position of the sun in the sky can be forecasted with certainty, the expected cloud cover forecast values will need to be used as inputs to any cloud cover algorithm. The resulting solar irradiance factor can be quantified in watts per square meter. While different bodies and body orientations will absorb solar heat differently, some generalizations can be made for the purposes of estimating the apparent temperature to an individual sitting in the sun at the venue on that day. Some cloud cover can increase the solar irradiation in the shade through scattering, and can also be factored in. The intricacies of refining the solar irradiance factor is beyond the scope of this invention but suffice it to say that the two primary values that results are (1) the apparent temperature in the shade; and (2) the apparent temperature in the sun.

FIG. 7 shows an exemplary selection form 700 for reviewing and selecting tickets among a group of user defined ‘Favorites’. The selection form 700 is divided primarily into two regions, a header region 710, and a ‘Favorites’ region 720. The header region 710 includes a search form comprising of an input field 712 and a search button 714. This enables the user to search the entire site upon entering a keyword or search phrase. The header region also contains two links; the first enables the user to email the page to another individual 716 and the second link allows the user to view user-defined ‘Favorites’ 718. Below the header region 710, the ‘Favorites’ region comprises a title 722 labeled “Favorites” followed by three other regions: an identity panel 726, a selection region 738, and an information panel 760.

The identity panel comprises a Title 728 which is the name of the Event, but may instead be the name of the Venue if different Event Names are represented on the page. The Venue Name 730, the Venue City 732, and State Name 734 are represented under the Title 728. In addition, there also exists a Find Others link 736 which enables the user to navigate away from the ‘Favorites’ to search for additional tickets.

The selection region 738 is below the identity panel 726 and displays both the ‘Favorite’ tickets 740 previously selected by the user and the corresponding graphical venue map 756. Each ‘Favorite’ ticket 740, has a set format which includes Price per Seat 754, Section 744, Row 746, Quantity 748, and the Date/Time 750. Also represented is an item letter symbol 752 that corresponds to the section labeled with the same venue map letter symbol 758 on the graphical venue map 756. The user may quickly determine the location of the tickets by comparing the item letter symbol 752 to the venue map letter symbol 758 on the graphical venue map 756. In addition, the user may remove a ticket from ‘Favorites by clicking on the star 742 to the left of the ticket.

Below the selection region 738, the information panel 760 displays detailed information about a “Favorite” ticket 740, which the user selects by clicking a specific “Favorite” ticket 740. The information provided includes the name and location of the event in the header 762, the item number 770, price 772, section 774, row 776, number of tickets available 778, date and time 780, and face price 782. Below this information is a Buy Ticket button 790 which directs users to a ticket seller's website to buy the selected tickets.

FIG. 8 shows an email 800 for sending selections of ‘Favorites’ to another user via electronic mail. The email 800 is divided primarily into three regions: a header region 810, a message region 820, and a ‘Favorites’ region 824. The header region 810 contains the recipient address 812, the sender address 814, and the subject 816. Below the header region 810, the message region 820 contains a personal message 822 from the user. The ‘Favorites’ region 824 is below the message region 820 and comprises an identity panel 826 and a selection region 838. The identity panel comprises a Title 828 which is the name of the Event, but may instead be the name of the Venue if different Event Names are represented on the page. The Venue Name 830, the Venue City 832, and State Name 834 are represented under the Title 828. In addition, there also exists a Find Others link 836 which enables the user to navigate away from the email 800 to the ticket search site 110 of FIG. 1 to search for additional tickets for that specific event, or venue.

The selection region 838 is below the identity panel 826 and displays both the ‘Favorite’ tickets 840 selected by the sender of the email and the corresponding graphical venue map 856. Each ‘Favorite’ ticket 840, has a set format which includes Price per Seat 854, Section 844, Row 846, Quantity 848, and the Date/Time 850. Also represented is an item letter symbol 852 that corresponds to the section labeled with the same venue map letter symbol 860 on the graphical venue map 856. The user may quickly determine the location of the tickets by comparing the item letter symbol 852 to the venue map letter symbol 860 on the graphical venue map 856. The star 842 to the left of the ticket designate it as belonging to a set of ‘Favorites’. In addition, there is a link 870 which enables the user to navigate to another page on the ticket search site 110 of FIG. 1 if there is difficulty viewing the email 800.

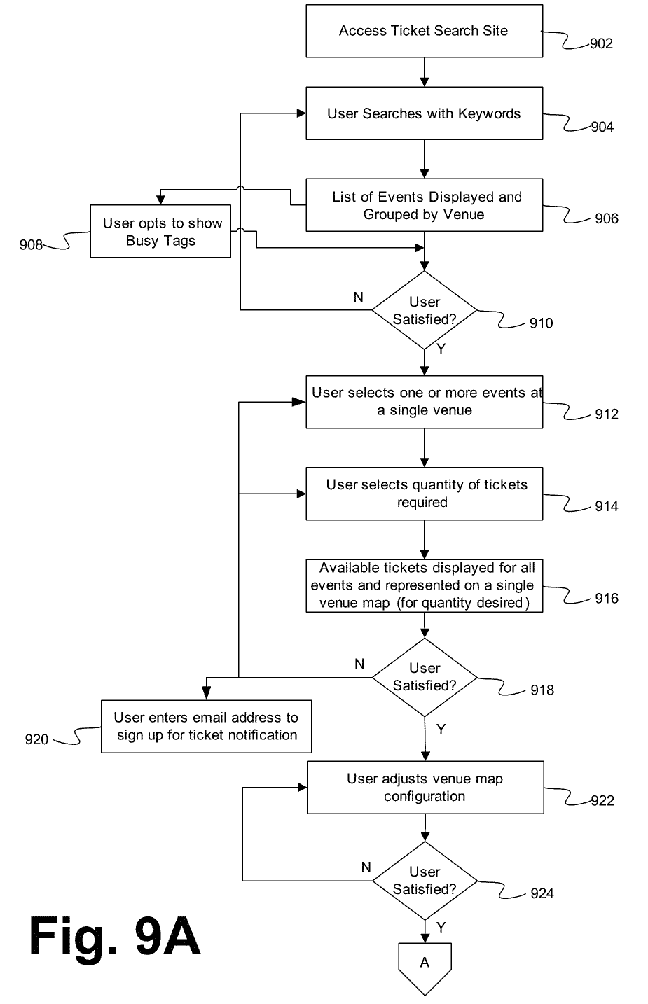

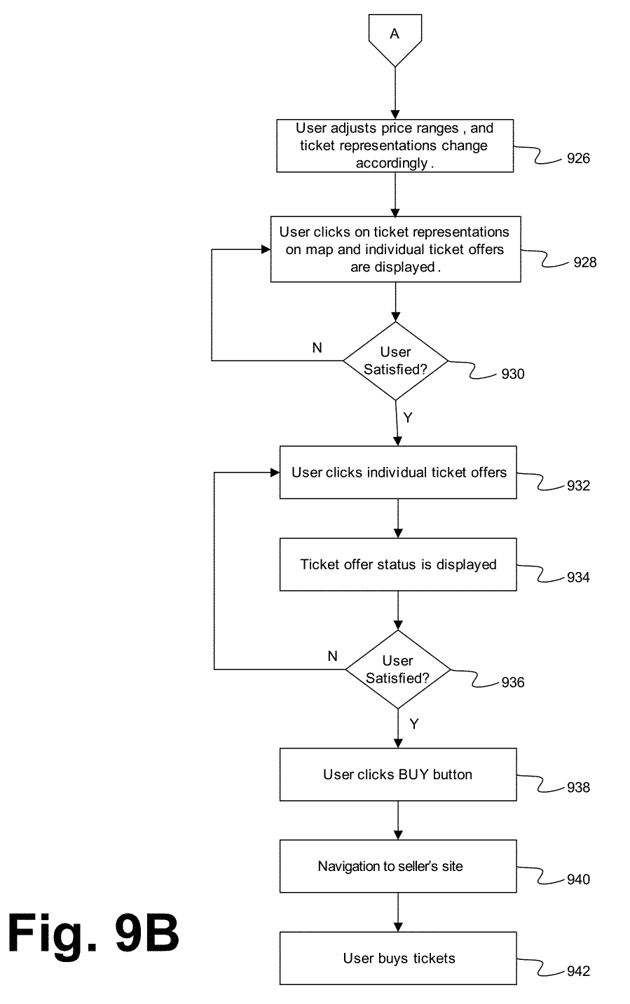

The process flow of FIGS. 9A-B is used to revisit the steps that a user takes at the online ticket search site by way of illustration. At step 902, the user accesses the ticket search site 110 of FIG. 1 from the user client station 150 of FIG. 1. The user then enters keywords and performs a search at step 904 by using the search form 200 of FIG. 2. At step 906, the user views the lists of events as retrieved from the database based on the search. The user may now opt to show busy tags 908 by using the login form 400 of FIG. 4 to access remote calendar information. At step 910, if the user is not satisfied, the user can return to step 904 to perform the search with different keywords. Otherwise, the user proceeds to step 912 and uses form 300 of FIG. 3 to select one or more events at a single venue and then the quantity of tickets required in step 914. At step 916, the available tickets are displayed for all events and represented on a single venue map on form 600 of FIG. 6. If in step 918 the user is not satisfied, the user may return to steps 912 or 914 to adjust the settings or the user may proceed to step 920 to sign up for an email notification so as to be advised when new tickets matching the previously defined specifications have been added. Otherwise, at step 922, the user adjusts the venue layout type to correspond to the type of event desired (eg. Concert, Tennis, Basketball, etc.). If the user is not satisfied at step 924, the user may return to step 922 to readjust the venue map configuration. At step 926, as shown in FIG. 9B, the user adjusts the price ranges and ticket representation change accordingly. At step 928, the user clicks on ticket representations on the graphical venue map and individual ticket offers are displayed. If the user is not satisfied at step 930, the user may return to step 928 to adjust selections. Otherwise, the user proceeds to step 932 and clicks on individual ticket offers. In step 934, detailed information regarding the ticket is displayed. If the user is not satisfied with this information in step 936, then the user may return to step 932 and select other ticket offers to view the status of those tickets. However, if the user is satisfied, the user may continue to step 938 and click the BUY button. This results in the user being redirected to the ticket seller's site at step 940, where the user buys the tickets at step 942.

Although the invention has been described in considerable detail in language specific to structural features and or method acts, it is to be understood that the invention defined in the appended claims is not necessarily limited to the specific features or acts described. Rather, the specific features and acts are disclosed as exemplary preferred forms of implementing the claimed invention. Stated otherwise, it is to be understood that the phraseology and terminology employed herein, as well as the abstract, are for the purpose of description and should not be regarded as limiting. Therefore, while exemplary illustrative embodiments of the invention have been described, numerous variations and alternative embodiments will occur to those skilled in the art. Such variations and alternate embodiments are contemplated, and can be made without departing from the spirit and scope of the invention.

In addition, reference to “first,” “second,” “third,” and etc. members throughout the disclosure (and in particular, claims) are not used to show a serial or numerical limitation but instead are used to distinguish or identify the various members of the group.

What is claimed is:

1. A method, comprising steps:
(a) displaying a symbol that is proportional n size to a number of search results in a aggregated georeferenced search result set, the symbol superimposed on a map in a position that geographically corresponds to a position attribute of the aggregated georeferenced search result set, the symbol comprising at least two areas that are essentially proportional in size to the number of results that have a price attribute value within price ranges that correspond to said at least two areas;
(b) enabling a user to dynamically modify parameters that define the limits of the price ranges through a price range modification mechanism;
(c) updating the at least two areas as the user manipulates said price range modification mechanism;
(d) enabling the user to dynamically modify environmental parameters comprising a temperature modification mechanism and a solar modification mechanism; and
(e) updating the number of search results as the user manipulates the environmental parameters.

2. The method of claim 1, wherein the user can select the symbol to obtain details of the number of search results that are members of the aggregated georeferenced search result set.

3. The method of claim 1, wherein the at least two areas are two areas.

4. The method of claim 3, wherein the limits of said price ranges share a common value between the two price ranges corresponding to the two areas.

5. The method of claim 4, wherein the price range modification mechanism modifies the common value.

6. The method of claim 1, wherein the price range modification mechanism comprises a price range continuum.

7. The method of claim 1, wherein the price range modification mechanism is a slider.

8. The method of claim 1, wherein the map is a seating layout for an event.

9. The method of claim 8, wherein the aggregated georeferenced search result set comprises seat availability data.

10. The method of claim 9, wherein the seat availability data comprises seat availabilities for multiple events.

11. The method of claim 1, wherein the map is a geographic map.

12. The method of claim 11, wherein the aggregated georeferenced search result set comprises real estate data.

13. The method of claim 11, wherein the aggregated georeferenced search result set comprises hotel room availability data.

14. The method of claim 9, wherein the temperature modification mechanism allows the user to filter average temperature between a first temperature value and a second temperature value, wherein the number of results are limited to seat availability data having an average apparent temperature between the first and second temperature values.

15. The method of claim 9, wherein the solar modification mechanism allows the user to filter the number of results to be limited to seat availability data having solar conditions including seats in direct sunlight, shade, or a combination thereof.

16. The method of claim 15, wherein the solar conditions are superimposed on the map.

17. The method of claim 15, wherein the solar conditions are displayed via a sun symbol comprising a plurality of sun rays, wherein the plurality of sun rays are colored either black or yellow depending on the solar conditions, wherein black corresponds to shade, and yellow corresponds to sun.

18. The method of claim 17, wherein the solar conditions are displayed in relation to time.

19. The method of claim 18, further comprising a rectangular horizontal bar graph comprising a first bar representing sun and a second bar representing shade, wherein the length of the first and second bar is dependent on time.

20. A system comprising:
an Internet-connected computerized appliance having a processor and coupled to a data repository, the processor executing software from a non-transitory medium, the software providing an interactive interface to a ticket search site, the system enabling a user to:
search through a plurality of ticket sellers for available seats at a plurality of events;
filter the available seats based on price;
filter the available seats based on temperature;
filter the available seats based on solar data; and
purchase the available seats.
